(19) United States
(12) Patent Application Publication
(10) Pub. No.: US 2008/0019516 A1
(43) Pub. Date: Jan. 24, 2008

(54) Enforced delay of access to digital content

(75) Inventor: Robert W. Fransdonk, Amstelveen (NL)

Correspondence Address: SCHWEGMAN, LUNDBERG & WOESSNER, P.A., P.O. BOX 2938, MINNEAPOLIS, MN, 55402, US

(73) Assignee: Entriq Inc.

(21) Appl. No.: 11/505,592

(22) Filed: Aug. 16, 2006

Related U.S. Application Data
(60) Provisional application No. 60/816,198, filed on Jun. 22, 2006.

(51) Int. Cl. H04N 7/167

(52) U.S. Cl. 380/201

(57) ABSTRACT

There is provided a method and system to enforce delay of access to encrypted digital content. The system includes a receiving module to receive a request for digital content and register a request time responsive to the receiving the request for digital content. The request for digital content includes a digital content identifier that identifies encrypted digital content. Next, a content distribution module communicates digital content information based on the request for digital content. The digital content information includes the encrypted digital content. Finally a license distribution module communicates a license that delays access to the encrypted digital content based on the request time.

### CLAIM OF PRIORITY

The present patent application claims the priority benefit of the filing date of Provisional Application No. 60/816,198 filed Jun. 22, 2006, the entire content of which is incorporated herein by reference.

### FIELD

This application relates generally to the technical field of processing digital content and, in one specific example, to enforced delay of access to digital content.

### BACKGROUND

Revenue from digital content such as video, audio, or multimedia, may typically be generated by users who pay a fee to access the digital content or by advertisers who pay for advertising that is shown with the digital content. The advertisement revenue is currently under threat by users that may use personal computers or digital video recorders (DVR) to avoid viewing the advertising. For example, DVR type technology makes it hard for broadcasters and content providers to ensure that the advertisements are actually watched by the users. Indeed, market research shows that 80% of DVR users skip advertisements.

### SUMMARY

According to a first aspect there is provided a method to enforce delay of access to encrypted digital content. The method includes receiving a request for digital content that includes a digital content identifier that identifies the encrypted digital content; registering a request time responsive to the receiving the request for digital content; communicating digital content information based on the request for digital content, the digital content information including the encrypted digital content; and communicating a license that delays access to the encrypted digital content based on the request time.

According to a second aspect there is provided a method to enforce delay of access to encrypted digital content. The method includes receiving a request for digital content that includes a digital content identifier that identifies the encrypted digital content; registering a request time responsive to receiving the request for digital content; communicating digital content information based on the request for digital content, the digital content information including the encrypted digital content; and communicating a license that enables decryption of the encrypted digital content, the communicating the license delayed, based on the request time, to delay access to the encrypted digital content.

According to a third aspect there is provided a method to enforce delay of access to unencrypted digital content. The method includes receiving a request for unencrypted digital content that includes a digital content identifier that identifies the unencrypted digital content; registering a request time responsive to the receiving the request for digital content; and communicating unencrypted digital content, the communication of the unencrypted digital content delayed, based on the request time, to delay access to the unencrypted digital content.

Other features of the present disclosure will be apparent from the accompanying drawings and from the detailed description that follows.

### BRIEF DESCRIPTION OF DRAWINGS

The present disclosure is illustrated by way of example and not limitation in the figures of the accompanying drawings, in which like references indicate similar elements and in which:

FIG. 1 is a network diagram depicting a system, according to one example embodiment of the present disclosure;

FIG. 2 is a block diagram illustrating requests, according to an example embodiment of the present disclosure;

FIG. 3 is a block diagram illustrating digital content information, an advertisement, a license, a digital content message and unencrypted digital content, according to one embodiment;

FIG. 4 is a block diagram illustrating timestamps, according to one embodiment;

FIG. 5 is a block diagram illustrating a license, according to one embodiment;

FIG. 6 is a block diagram illustrating a playlist, according to one embodiment;

FIG. 7 is a block diagram illustrating a database, according to one embodiment, at the content server;

FIG. 8 is a block diagram illustrating a database, according to one embodiment, at the advertisement server;

FIG. 9 is a block diagram illustrating a database, according to one embodiment, at the user computer;

FIGS. 10 and 11 are flow charts illustrating a method, according to one embodiment, to delay access to encrypted digital content;

FIGS. 12 and 13 are flow charts illustrating a method, according to one embodiment, to delay access to encrypted digital content;

FIGS. 14 and 15 are flow charts illustrating a method, according to one embodiment, to delay access to unencrypted digital content;

FIG. 16 is a flow chart illustrating a method, according to one embodiment, to determine access rights to digital content; and

FIG. 17 is a block diagram of a machine, according to one embodiment.

### DETAILED DESCRIPTION

In the following description, for purposes of explanation, numerous specific details are set forth in order to provide a thorough understanding of an embodiment of the present disclosure. It will be evident, however, to one skilled in the art that the present disclosure may be practiced without these specific details.

Broadly speaking, described below are methods and systems to enforce delay of access to encrypted digital content and unencrypted digital content. According to three aspects a request for digital content (e.g., Movie, Music Video, etc.) is received that includes a digital content identifier that identifies encrypted digital content or unencrypted digital content. Responsive to receiving the request for digital content a request time is registered (e.g., stored). According to the first aspect, a delay of access to the encrypted digital content may be enforced at a decryption engine based on an attribute in a license that is required by the decryption engine to decrypt the encrypted digital content. The decryption engine ignores all requests to decrypt the encrypted digital content until a decryption delay time after the request time. According to the second aspect, the delay of access to the encrypted digital content may be enforced at license server based on a license delay time. The license server does not communicate a license that is required by the decryption engine to decrypt the encrypted digital content until a license delay time after the request time. According to the third aspect, the delay of access to unencrypted digital content may be enforced at a content server based on a content delay time. The content server does not communicate the unencrypted digital content to a user computer until a content delay time after the request time.

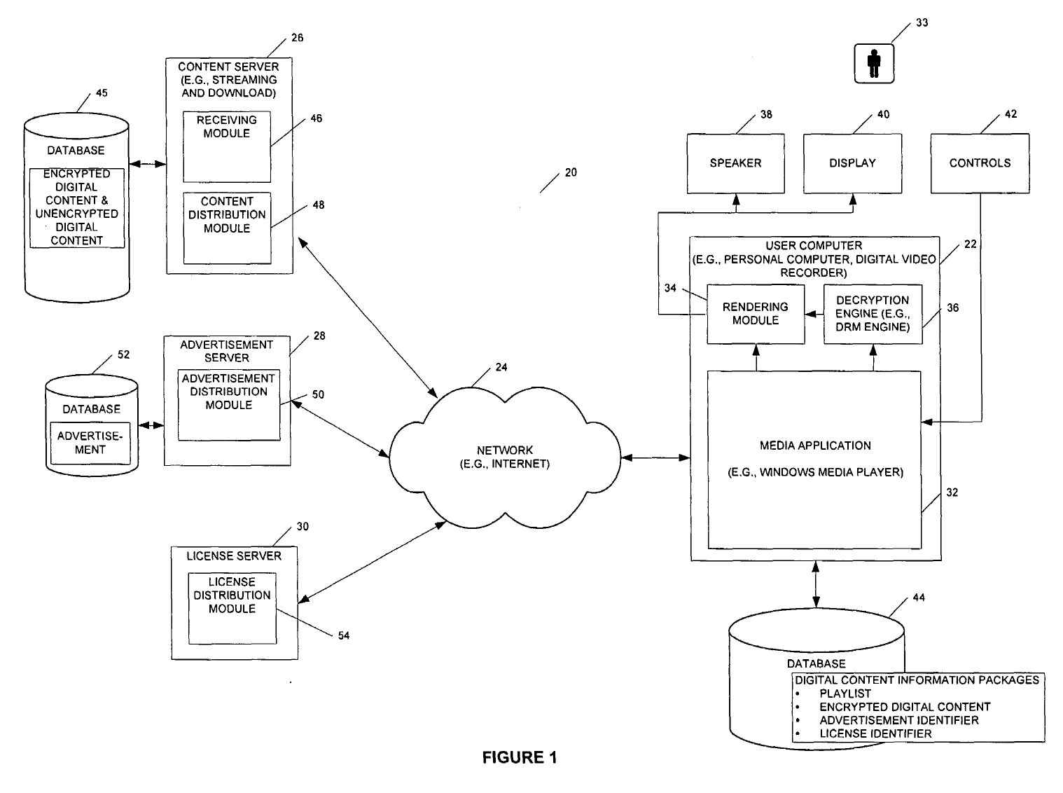

FIG. 1 is a network diagram depicting a system 20, according to one example embodiment of the present disclosure. The system 20 is shown to include a user computer 22 that communicates over a network 24 with a content server 26, an advertisement server 28, and a license server 30. The network 24 may include a cable television distribution network, a satellite distribution network, a broadcast television distribution network, a data packet-based computer network (e.g., an Ethernet network, Internet, etc.), and the like. Broadly speaking, a user 33 operates the user computer 22 to communicate a request (e.g., digital content request) for digital content to the content server 26. The request may include a digital content identifier that identifies digital content (e.g., video, audio, multimedia, etc.) and a user identifier that identifies the user 33 operating the user computer 22. For example, the user 33 may download encrypted digital content to the user computer 22 where it may be stored and repeatedly played or the user 33 may stream encrypted stream digital content to the user computer 22 for a single play. The user computer 22 is shown to include a media application 32, a rendering module 34, and a decryption engine 36. Further, the user computer 22 is shown to be connected to a speaker 38, a display 40, controls 42, and a database 44. In another embodiment, the user computer 22 may be embodied as a digital video recorder. For example, the user computer 22 may be embodied as the digital video recorder made by TiVo of Alviso, Calif.

The media application 32 responds to the user 33 who provides input via one or more user interfaces and operates the controls 42 (e.g., keyboard, mouse, etc.) to facilitate the retrieval of the digital content and to play the digital content. For example, the media application 32 may be embodied as a Window Media Player made by Microsoft Corporation of Redmond, Wash. The media application 32 may communicate requests (e.g., digital content request) for digital content and receive digital content information or a digital content message responsive to the request. Digital content information may include a playlist, a license identifier to retrieve a license from a license server, an optional advertisement identifier to retrieve an advertisement from an advertisement server, and encrypted digital content. The media application 32 may further read commands from the playlist and execute the commands. For example, the media application 32 may execute a play digital content command that commands decryption engine 36 to decrypt the encrypted digital content and to communicate the resulting digital content to the rendering module 34. The media application 32 may also communicate the encrypted digital content to the decryption engine 36 and the advertisement to the rendering module 34. The rendering module 34 may render the advertisement and the digital content to cause sound on the speaker 38 and images on the display 40.

The decryption engine 36 may receive encrypted digital content and a license. The decryption engine 36 requires a license that corresponds to the encrypted digital content to access and decrypt the encrypted digital content. In one embodiment, the decryption engine 36 may utilize the Electronic Media Management System (EMMS) by IBM Corporation of Somers, N.Y. In another embodiment, the decryption engine 36 may utilize the Windows Media Rights Manager by Microsoft Corp. of Redmond, Wash.

The database 44 is shown to store digital content information packages including the playlist, the encrypted digital content, the advertisement identifier, and the license identifier. The database 44 may store digital content information packages to facilitate playing encrypted digital content that has been previously been downloaded from the content server 26.

The content server 26 may be dedicated for streaming or downloading digital content to the user computer 22 and is shown to be connected to a database 45 that stores encrypted digital content and unencrypted digital content. Further, the system 20 may include multiple content servers 26 that may respectively be dedicated for downloading or streaming digital content. For example, the system 20 may include a first content server 26 to service user requests (e.g., from the user computer 22) to download digital content to the user computer 22 and a second content server 26 to service users requests to stream digital content to the user computer 22. The content server 26 is shown to include a receiving module 46 and a content distribution module 48. The receiving module 46 may receive and process requests from the media application 32. The content distribution module 48 may communicate the digital content information or the digital content message to the media application 32 responsive to the request. Further, the content distribution module 48 may access the database 45 to retrieve user profile information, digital content information, and policy information to respond to the request.

The advertisement server 28 includes an advertisement distribution module 50 and is shown to be connected to a database 52 that stores advertisements. The advertisement server 28 may receive a request for an advertisement from the user computer 22. Responsive to the request, the advertisement distribution module 50 may communicate the advertisement to the user computer 22.

The license server 30 includes a license distribution module 54. The license server 30 may receive a request from the media application 32. Responsive to the request, the license distribution module 54 may communicate the license to the user computer 22.

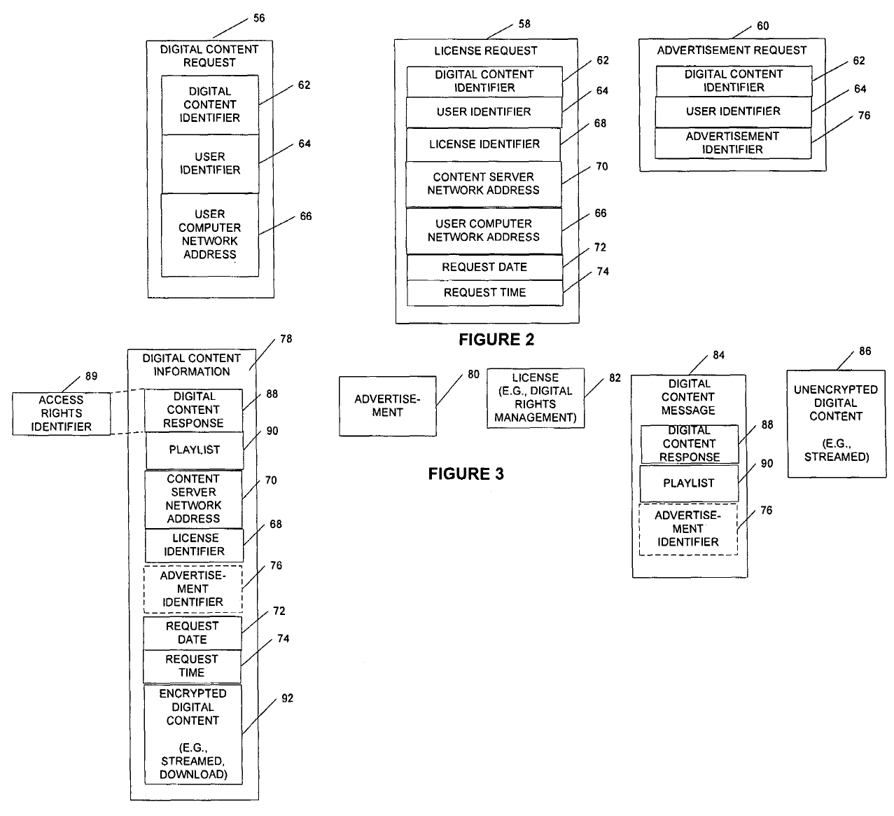

FIG. 2 is a block diagram illustrating a digital content request 56, a license request 58, and an advertisement request 60, according to one embodiment. The digital content request 56 includes a digital content identifier 62 that identifies digital content requested by the user 33, a user identifier 64 that identifies the user 33 requesting the digital content, and a user computer network address 66 (e.g., Internet Protocol Address) that identifies the user computer 22 that was used to request the digital content. The digital content request 56 may be communicated from the media application 32 to the receiving module 46 at the content server 26 to request digital content (e.g., encrypted digital content or unencrypted digital content) from the content server 26. Further, the digital content request 56 may be communicated to the appropriate content server 26 based on the request from the user 33. For example, the digital content request 56 may be communicated to the content server 26 dedicated to downloading to service a request for downloaded encrypted digital content or communicated to the content server 26 dedicated to streaming digital content to service a request for streaming digital content.

The license request 58 may be communicated from the media application 32 to the license server 30 to request a license. The license request 58 includes the digital content identifier 62, the user identifier 64, a license identifier 68, a content server network address 70, the user computer network address 66, a request date 72, and a request time 74. The license identifier (e.g., Universal Resource Locater, URL) may identify the location of the license server 30 on the network 24 and in some embodiments may further identify a specific license. The content server network address 70 (e.g., URL) may identify the location of the content server 26 on the network 24. The request date 72 is the date the content server 26 received the digital content request 56 and the request time 74 is the time the content server 26 received the digital content request 56.

The advertisement request 60 may be communicated from the media application 32 to the advertisement server 28 to request an advertisement. The advertisement request 60 includes the digital content identifier 62, the user identifier 64, and an advertisement identifier 76. The advertisement identifier 76 (e.g., Universal Resource Locater, URL) may identify the location of the advertisement server 28 on the network 24 and in some embodiments may further identify a specific advertisement.

FIG. 3 includes block diagrams illustrating digital content information 78, an advertisement 80, a license 82, a digital content message 84, and unencrypted digital content 86, according to one embodiment. The digital content information 78 may be communicated by the content distribution module 48 to the media application 32. The digital content information 78 may include a digital content response 88 that may be used to store an access rights identifier 89 that identifies the access rights of the user 33 responsive to the request of the user 33 (e.g., the digital content request 56). For example, the access rights identifier 89 may indicate the content server 26 grants access to digital content after enforcing a delay (e.g., advertisement) or grants access to the digital content or denies access to the digital content. The digital content information 78 may further include a playlist 90, the content server network address 70, the license identifier 68, the advertisement identifier 76, the request date 72, the request time 74 and encrypted digital content 92. The playlist 90 may include commands that may be executed by the media application 32. The advertisement identifier 76 may be included in the digital content information 78 if the digital content information 78 indicates that a delay may be enforced. The encrypted digital content 92 may be streamed or downloaded to the user computer 22.

The advertisement 80 may be a commercial presentation, a public announcement, or a legal warning and may be communicated by the advertisement server 28 to the user computer 22 responsive to the advertisement request 60.

The license 82 may be a digital rights management license as previously described and may be communicated by the license server 30 to the user computer 22.

The digital content message 84 may be communicated by the content server 26 to the user computer 22 responsive to the digital content request 56. The digital content message 84 may include the digital content response 88, the playlist 90 and the advertisement identifier 76. The advertisement identifier 76 may be included in the digital content message 84 based on the digital content response 88. For example, if the digital content response indicates that a delay may be enforced (e.g., advertisement) then the advertisement identifier 76 may be included in the digital content message 84.

The unencrypted digital content 86 may be communicated by the content server 26 to the user computer 22 in response to the digital content request 56. The unencrypted digital content 86 may be immediately communicated if a delay is not enforced. Otherwise the unencrypted digital content 86 may be communicated a content delay time after the request time 74 (e.g., delay is enforced).

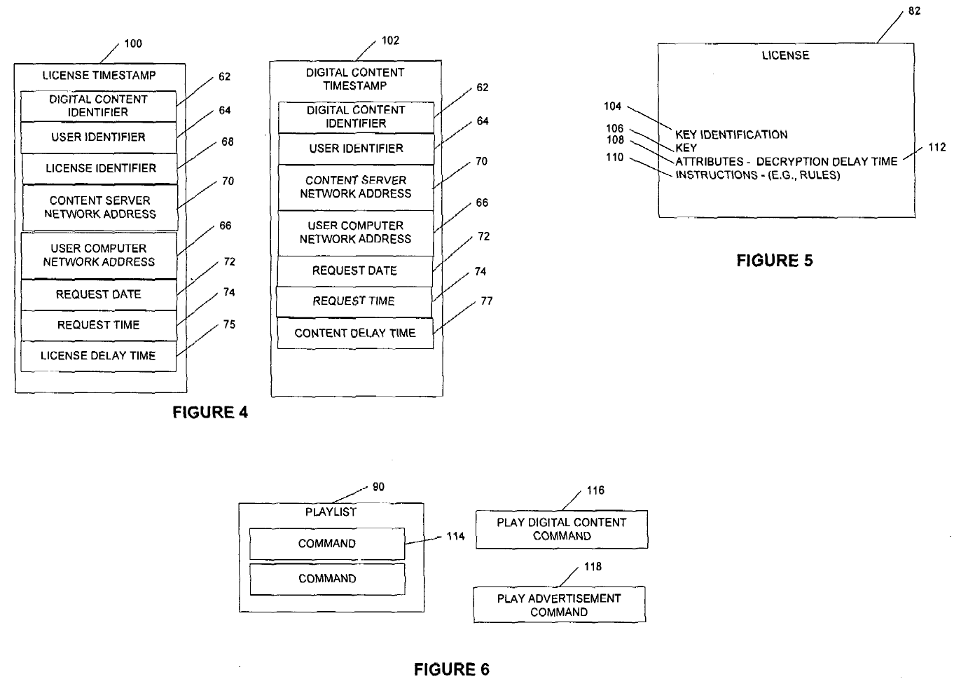

FIG. 4 is a block diagram illustrating a license timestamp 100 and a digital content timestamp 102, according to one embodiment. The license timestamp 100 may be queued on a license timestamp queue by the license server 30 responsive to the license request 58, according to one embodiment. The license timestamp 100 may be queued to delay access to the corresponding encrypted digital content 92. For example, the license timestamp 100 may be queued on the license timestamp queue to delay communicating the license 82 for a license delay time 75 after the request time 74. The license distribution module 54 may generate the license delay time 75 based on the license request 58. The license timestamp 100 includes the digital content identifier 62, the user identifier 64, the license identifier 64, the content server network address 70, the user computer network address 66, the request date 72, the request time 74, and the license delay time 75.

The digital content timestamp 102 may be queued on a digital content timestamp queue by the content server 26 responsive to the digital content message 84, according to one embodiment. The digital content timestamp 102 may be queued to delay access to the corresponding unencrypted digital content 86. For example, the digital content timestamp 102 may be queued on the digital content timestamp queue to delay communicating the unencrypted digital content 86 for a content delay time 77 after the request time 74. The digital content timestamp 102 includes the digital content identifier 62, the user identifier 64, the content server network address 70, the user computer network address 66, the request date 72, the request time 74, and the content delay time 77.

FIG. 5 is a block diagram illustrating a license 82, according to one embodiment. The license 82 may be used by the decryption engine 36 to control access to the corresponding encrypted digital content 92. For example, the decryption engine 36 may decrypt the corresponding encrypted digital content 92 according to the contents of the license 82. The license 82 is shown to include a key identification 104 that may be used to associate the license 82 to corresponding encrypted digital content 92, a key 106 that may be used by the decryption engine 36 to decrypt the encrypted digital content 92, attributes 108 that may be used to control access to the encrypted digital content 92, and instructions 110 (e.g., rules) that may be executed by the decryption engine 36. The attributes 108 may include a decryption delay time 112 that may be used by the decryption engine 36 to delay decryption of the encrypted digital content. For example, in one embodiment, the decryption engine 36 may execute the instructions 110 to add the decryption delay time 112 to the request time 74 to generate a delay expiration time that may be compared with the current time. Continuing with the example, if the current time is later than the delay expiration time then the decryption engine 36 may grant a request to decrypt the encrypted digital content 92. Otherwise the decryption engine 36 may deny a request to decrypt the encrypted digital content 92.

FIG. 6 is a block diagram illustrating the playlist 90, according to one embodiment. The playlist 90 may be communicated by the content server 26 to the user computer 22 and may include one or more commands 114 that may be executed by the media application 32. The commands 114 may include a play digital content command 116 and a play advertisement command 118. The play digital content command 116 may be communicated by the media application 32 to the decryption engine 36 to request decryption and playing of the encrypted digital content 92. In addition the play advertisement command 118 may be communicated by the media application 32 to the rendering module 34 to play the advertisement 80.

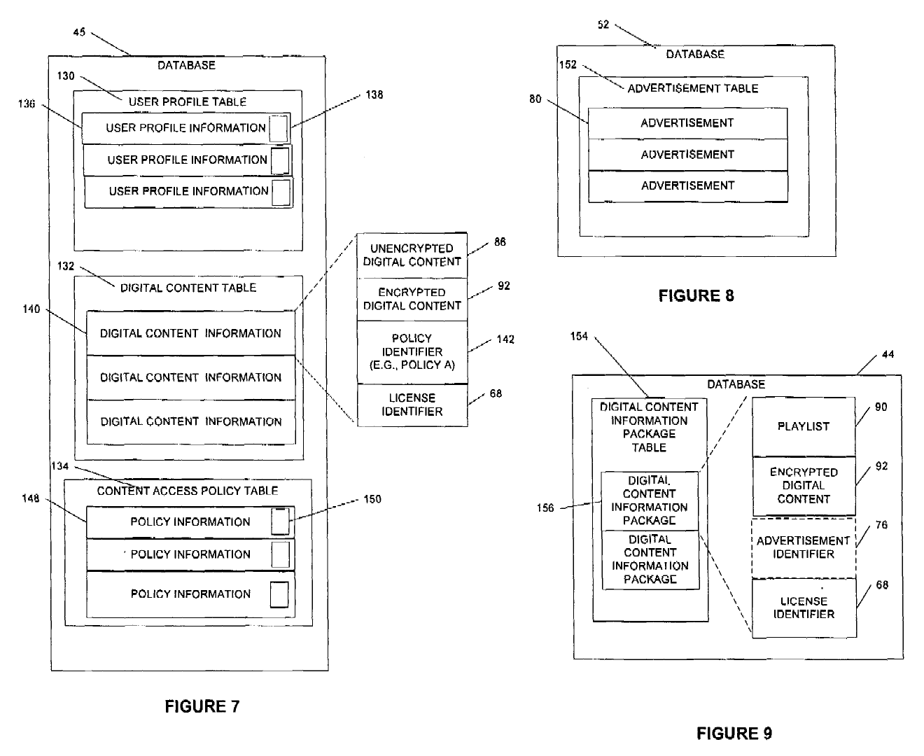

FIG. 7 is a block diagram illustrating the database 45, according to one embodiment, that may be accessed by the content server 26. The database 45 is shown to include a user profile table 130, a digital content table 132, and a content access policy table 134. The user profile table 130 includes multiple user profile information 136 entries that may be accessed according to the respective user identifier 64. The user profile information 136 may be used by the content server 26 to determine the rights of the associated user to access digital content. For example, the user profile information 136 may include a subscription flag 138 that may indicate (e.g., asserted) that a monthly subscription fee (e.g., $10.00 per month) is paid by the user to receive digital content or to receive digital content without advertisements.

The digital content table 132 includes multiple digital content information 140 entries that may be accessed by the content server 26 based on the digital content identifier 62. The digital content information 140 is shown to include the unencrypted digital content 86, the encrypted digital content 92, a policy identifier 142 that may be used to access policy information that is associated with the corresponding unencrypted digital content 86 and the encrypted digital content 92, and the license identifier 68. The policy identifier 142 may be changed at any time, even after the unencrypted digital content 86 or the encrypted digital content 92 is publicly available, according to one embodiment. The unencrypted digital content 86 and the encrypted digital content 92 may include video digital content, multimedia digital content, or audio digital content.

The content access policy table 134 includes policy information 148 entries that may be accessed by the content server 26 based on the policy identifier 142. The policy information 148 includes an access policy 150 that may be used by the content server 26 to determine the rights of the user 33 to access the content 86, 92 that is associated with the access policy 150. For example, the access policy 150 may require the user 33 to subscribe to an entertainment service (e.g., HBO, Showtime, etc.) to access the associated content 86, 92 or the access policy 150 may require the advertisement 80 be played to the user 33 to access the associated content 86, 92 or the access policy 150 may require the advertisement 80 be played to the user 33 unless the user has paid a subscription fee to access the associated content 86, 92.

FIG. 8 is a block diagram illustrating the database 52, according to one embodiment, that may be accessed by the advertisement server 28. The database 52 is shown to include an advertisement table 152 that may be accessed by the advertisement server 28 based on the advertisement identifier 76. The advertisement table 152 includes multiple advertisement 80 entries. For example, the advertisement 80 may include a commercial presentation, a public announcement or a legal warning. Further, the advertisement 80 may be formatted according to multimedia, video, or audio standards.

FIG. 9 is a block diagram illustrating the database 44, according to one embodiment, that may be accessed by the user computer 22. The database 44 is shown to include a digital content information package table 154. The digital content information package table 154 includes digital content information packages 156 that may have been downloaded by the user 33 from the content server 26 and stored in the digital content information package table 154. Each digital content information package 156 is shown to include the playlist 90, the encrypted digital content 92, the advertisement identifier 76, and the license identifier 68. The digital content information package 156 may not include the advertisement identifier 76. The digital content information package 156 may be selected by the user 33 to play the corresponding encrypted digital content 92 on the user computer 22. For example, selection of the digital content information package 156 may invoke the media application 32 to perform one or more functions including executing the playlist 90, requesting the license 82 from the license server 30 based on the license identifier 68, requesting the decryption engine 36 to decrypt the encrypted digital content 92, and requesting the advertisement 80 from the advertisement server 28 based on the advertisement identifier 76. Further, selection of the digital content information package 156 may result in enforcement of delay to access the encrypted digital content 92.

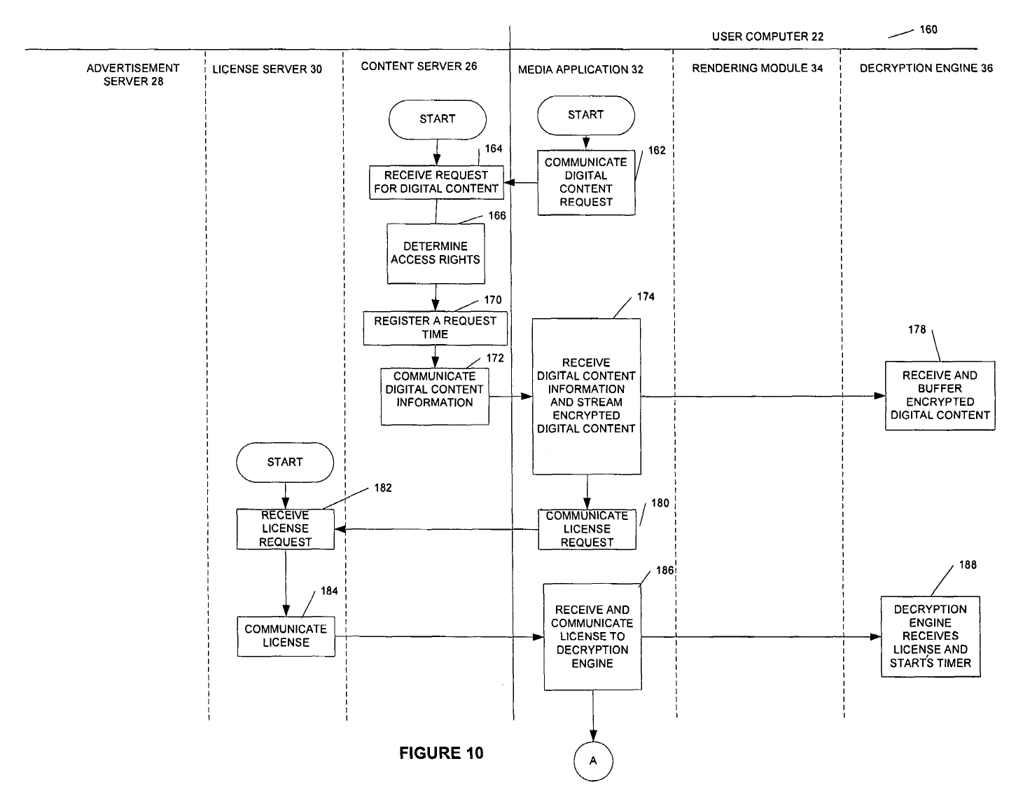

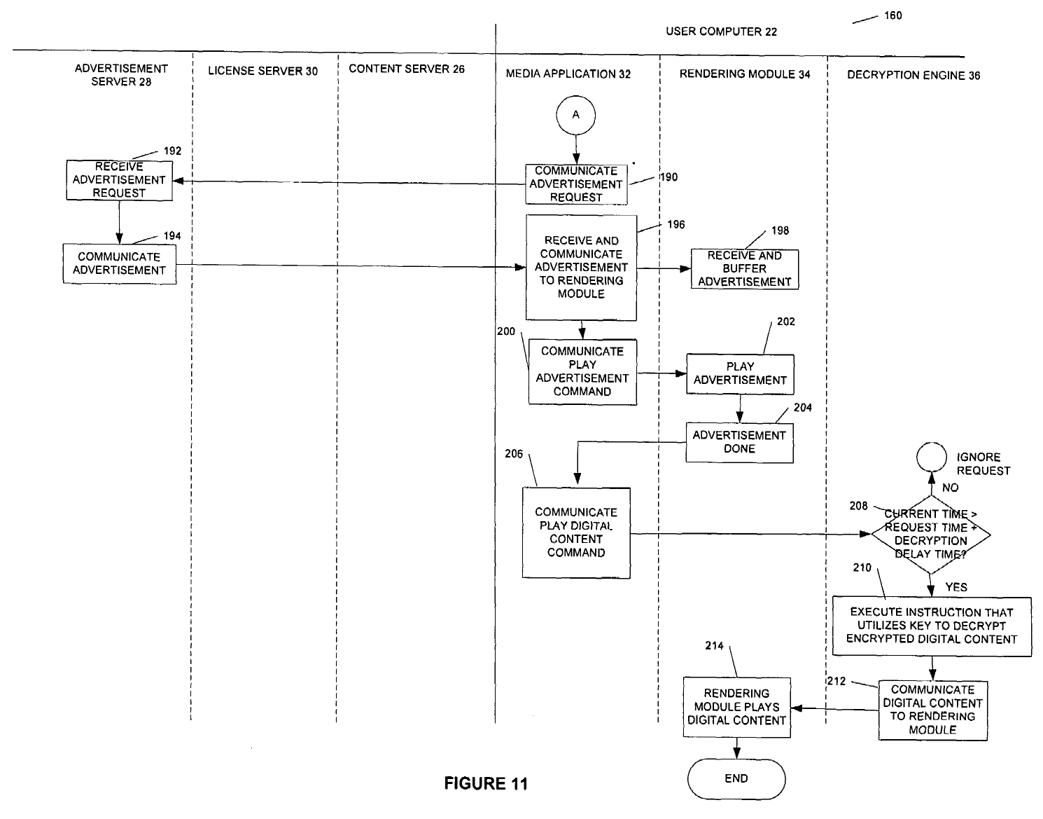

FIGS. 10 and 11 are flow charts illustrating a method 160, according to one embodiment, to enforce delay of access to encrypted digital content (e.g., at the decryption engine 36). Illustrated on the left of FIG. 10 are the advertisement server 28, the license server 30, and the content server 26. Illustrated on the right is the user computer 22 including the media application 32, the rendering module 34 and the decryption engine 36. The method 160 commences at the operation 162 with the user 33 requesting the digital content. For example, the user may select a user interface element that causes the digital content request 56 to be generated and communicated to the content server 26 (e.g., a request to stream). The digital content request 56 may include the digital content identifier 62, the user identifier 64 and the user computer network address 66. In one embodiment, the request to stream is implied by the content server 26 that receives the digital content request 56.

At operation 164, the receiving module 46, at the content server 26, receives the digital content request 56.

At operation 166 the receiving module 46 determines the access rights of the user 33. For example, the user 33 may be granted access to the requested digital content after the system enforces a delay (e.g., plays the advertisement 80), granted access without enforcing a delay, or denied access. In the present example, the user 33 is granted access to the encrypted digital content 92 after the system 20 enforces a delay. Accordingly, the determined access rights of the user 33 are associated with the appropriate access rights identifier 89 that may be stored in the digital content response 88 of the digital content information 78. The present example also illustrates that the media application 32 may play the advertisement 80 during the enforced delay.

At operation 170, the receiving module 46 registers the request time. For example, the receiving module 46 may store the current date in the request date 72 field of the digital content information 78 and the current time in the request time 74 field of the digital content information 78.

At operation 172, the content distribution module 48 communicates the digital content information 78 to the user computer 22, the digital content information 78 including the digital content response 88, the playlist 90, the content server network address 70, the license identifier 68, the advertisement identifier 76, the request date 72, the request time 74 and the encrypted digital content 92 (e.g., streamed). The content distribution module 48 may generate the playlist 90 based on the digital content request 56 and the access rights of the user (e.g., access rights identifier 89). In the present example, the playlist 90 may include the play advertisement command 118 and the play digital content command 116. The content distribution module 48 may read the license identifier 68 and the encrypted digital content 92 from the digital content table 132 based on the digital content identifier 62. Finally, the content distribution module 48 may generate the advertisement identifier 76 based on the digital content identifier 62 and/or the user identifier 64 and/or user computer network address 66.

At operation 174, the media application 32, at the user computer 22, receives the digital content information 78 and streams the encrypted digital content 92 to the decryption engine 36.

At operation 178, the decryption engine 36 receives and buffers the encrypted digital content.

At operation 180, the media application communicates the license request 58 to the license server 30. For example, the license request 58 may include the digital content identifier 62, the user identifier 64, the license identifier 68, the content server network address 70, the user computer network address 66, the request date 72, and the request time 74.

At operation 182, the license server 30 receives the license request 58. At operation 184, the license distribution module 54, at the license server 30 generates and communicates the license 82 to the user computer 22. The license distribution module 54 may generate the license 82 based on the license request 58. For example, in one embodiment the digital content identifier 62 may be used to identify or generate the contents of the license 82 (e.g., attributes 108, instructions 110, etc.). In another embodiment, other fields in the license request 58 (e.g., digital content identifier 62, the user identifier 64, the license identifier 68, etc.) may be used to generate the license 82. In yet another embodiment combinations of fields in the license request 58 (e.g., digital content identifier 62, the user identifier 64, the license identifier 68, etc.) may be used to generate the license 82.

At operation 186, the media application 32, at the user computer 22, receives and communicates the license 82 to the decryption engine 36. At operation 188, the decryption engine 36, at the user computer 22, receives the license 82.

Continuing on FIG. 11, at operation 190, the media application 32, at the user computer 22 communicates the advertisement request 60 to the advertisement server 28. For example, the advertisement request 60 may include the digital content identifier 62, the user identifier 64, and the advertisement identifier 76.

At operation 192, the advertisement distribution module 50, at the advertisement server 28, receives the advertisement request 60. At operation 194, the advertisement distribution module 50 reads the advertisement 80 from the advertisement table 152 based on the advertisement identifier 76 and communicates the advertisement 80 to the user computer 22. Other embodiments may include the advertisement distribution module 50 retrieving or generating the advertisement 80 based on one or more fields in the advertisement request 60 (e.g., digital content identifier 62, the user identifier 64, the advertisement identifier 76).

At operation 196, at the user computer 22, the media application 32 receives and communicates the advertisement 80 to the rendering module 34. At operation 198, the rendering module 34 receives and buffers the advertisement 80.

At operation 200, the media application 32, executes the play advertisement command 118 in the playlist 90 by requesting the rendering module to play the advertisement 80. At operation 202, the rendering module 34 receives the request to play the advertisement and plays the advertisement on the speaker(s) 38 and display 40. At operation 204, the rendering module 34 signals the media application 32 that the advertisement has completed playing the advertisement 80.

At operation 206, the media application 32, executes the play digital content command 116 on the playlist 90 by requesting the decryption engine 36 to decrypt and to play the encrypted digital content 92.

At decision operation 208, the decryption engine 36 receives the request to encrypt and to play the encrypted digital content 92 and responsive to the request, executes the instructions 110 (e.g., rules) contained by the license 82. The decryption engine 36 may ignore the request to decrypt the encrypted digital content 92 if the request is received before the enforced delay has expired. For example, the instructions 110 may add the decryption delay time 112 in the license 82 to the request time 74 in the digital content information 78 to generate a delay expiration time that is compared to the current time. If the current time is greater than delay expiration time then the request to decrypt the encrypted digital content is granted and processing continues at operation 210. Otherwise the request to decrypt the encrypted digital content is ignored.

At operation 210, the decryption engine 36 executes instructions 110 that use the key 106 to decrypt the encrypted digital content 92. At operation 212, the decryption engine 36 communicates the unencrypted digital content 86 to the rendering module 34.

At operation 214, the rendering module 34 plays the unencrypted digital content 86 on the speaker(s) 38 and the display 40.

In another example, the media application may receive a request to download rather than stream the encrypted digital content 92, as illustrated above. In the download example, the media application 32 may communicate the digital content request 56 to the content server 26 that services requests to download the encrypted digital content 92. Further, the media application 32 may utilize the received digital content information 78 to generate and store the digital content information package 156 in the digital content information package table 154 in the database 44. The user 33 may subsequently play the encrypted digital content 92 by retrieving the encrypted digital content 92 from the digital content information package table 154 rather than the content server 26. Note that a delay remains enforced and the advertisement 80 is played whether the encrypted digital content 92 is downloaded from the content server 26 or retrieved from the digital content information package table 154.

In another example, the selected encrypted digital content 92 may be played or accessed without enforcing the delay. In another example, the user may be denied access to the encrypted digital content 92.

In yet another example, the user 33 may request digital content that may be communicated to the user computer 22 as multiple encrypted digital contents 92. For example, the user may request two episodes of the “Star Trek” series. Responsive to the request, the system 20 may communicate digital content information 78 that includes a first encrypted digital content 92 (e.g., first episode) and a second encrypted digital content 92 (e.g., second episode). The first encrypted digital content 92 associated with a first license 82 and a first advertisement 80, and the second encrypted digital content 92 associated with a second license 82 and a second advertisement 80.

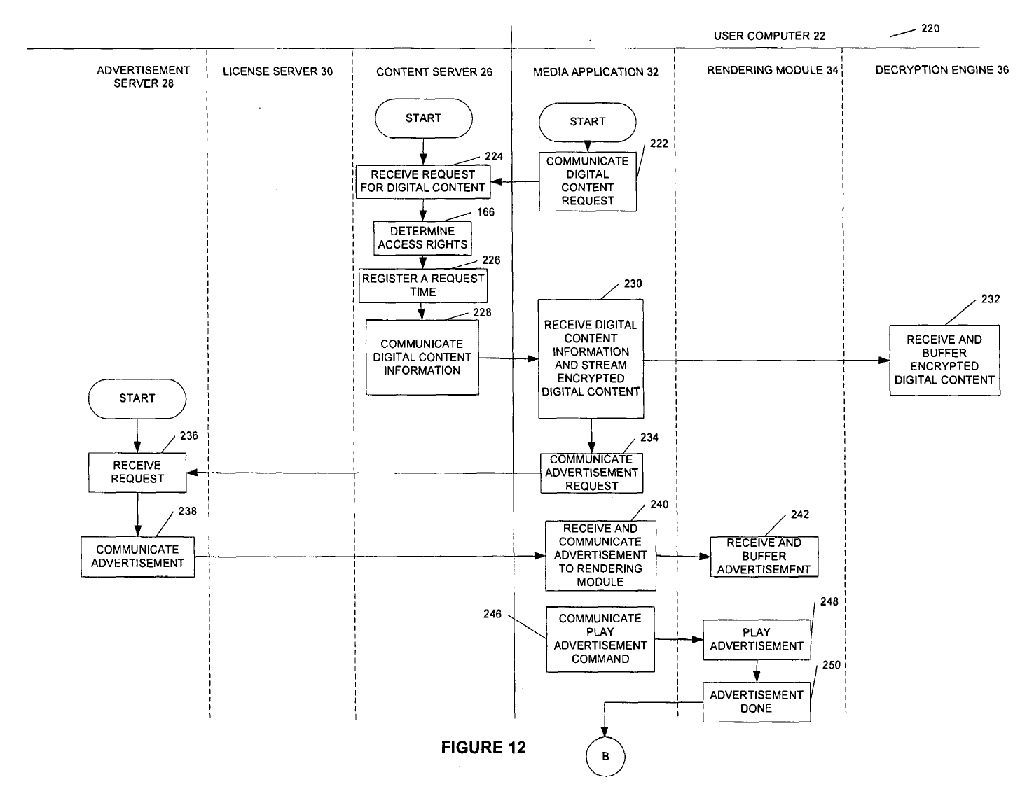

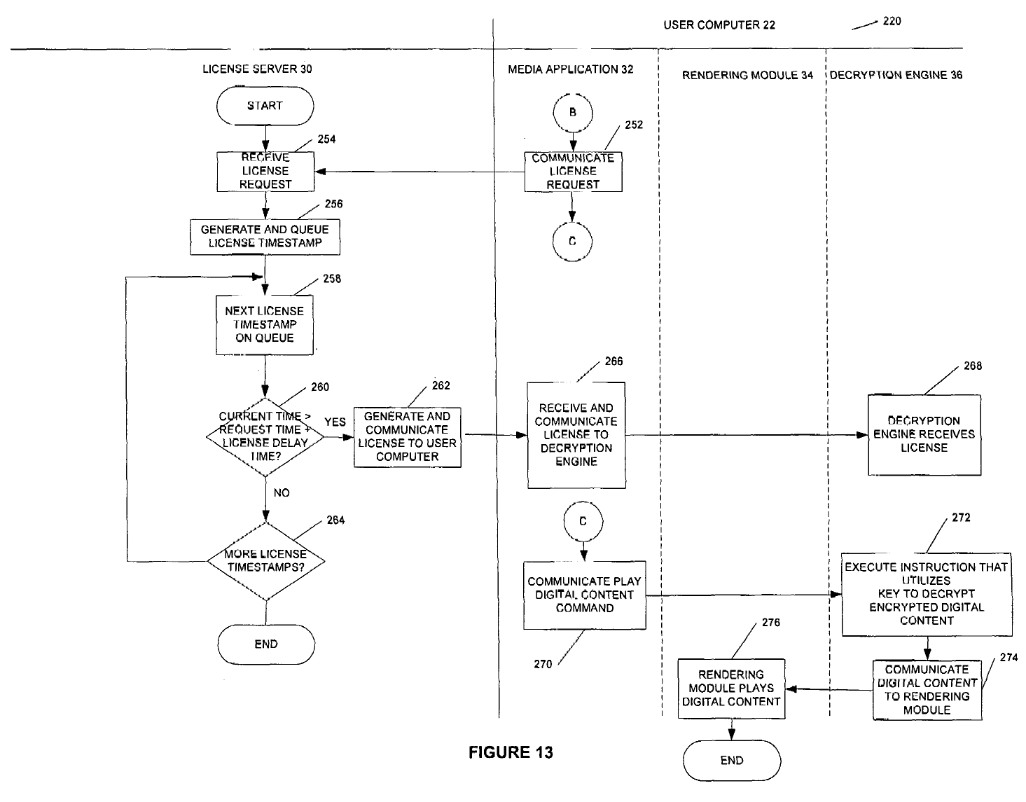

FIGS. 12 and 13 are flow charts illustrating a method 220, according to one embodiment, to enforce delay of access to encrypted digital content (e.g., at the license server 30). Illustrated on the left of FIG. 12 are the advertisement server 28, the license server 30, and the content server 26. Illustrated on the right is the user computer 22 including the media application 32, the rendering module 34 and the decryption engine 36. The method 220 commences at the operation 222 with the user 33 requesting the digital content. For example, the user may select a user interface element that causes the digital content request 56 to be generated and communicated to the content server 26 (e.g., a request to stream). The digital content request 56 may include the digital content identifier 62, the user identifier 64, and the user computer network address 66. In one embodiment, the request to stream is implied by the content server 26 that receives the digital content request 56.

At operation 224, the receiving module 46, at the content server 26, receives the digital content request 56.

At operation 166 the receiving module 46 determines the access rights of the user 33 and stores the access rights identifier 89 in the digital content response 88 of the digital content information 78. In the present example, the user 33 is granted access to the encrypted digital content 92 after the system 20 enforces a delay. Accordingly, the determined access rights of the user 33 are associated with the appropriate access rights identifier 89 that may be stored in the digital content response 88 of the digital content information 78. The present example also illustrates that the media application 32 may play the advertisement 80 during the enforced delay.

At operation 226, the receiving module 46 registers a request time responsive to receiving the request for digital content. For example, the receiving module 46 may store the current date in the request date 72 field of the digital content information 78 and the current time in the request time 74 field of the digital content information 78.

At operation 228, the content distribution module 48 communicates the digital content information 78 to the user computer 22, the digital content information 78 including the digital content response 88, the playlist 90, the content server network address 70, the license identifier 68, the advertisement identifier 76, the request date 72, the request time 74 and the encrypted digital content 92 (e.g., streamed). The content distribution module 48 may generate the playlist 90 based on the digital content request 56 and the access rights of the user (e.g., access rights identifier 89). In the present example, the playlist 90 may include the play advertisement command 118 and the play digital content command 116. The content distribution module 48 may read the license identifier 68 and the encrypted digital content 92 from the digital content table 132 based on the digital content identifier 62. Finally, the content distribution module 48 generates the advertisement identifier 76 based on the digital content identifier 62 and/or the user identifier 64 and/or user computer network address 66.

At operation 230, the media application 32, at the user computer 22, receives the digital content information 78 and streams the encrypted digital content 92 to the decryption engine 36.

At operation 232, the decryption engine 36 receives and buffers the encrypted digital content 92.

At operation 234, the media application 32, at the user computer communicates the advertisement request 60 to the advertisement server 28. For example, the advertisement request 60 may include the digital content identifier 62, the user identifier 64, and the advertisement identifier 76.

At operation 236, the advertisement server 28 receives the advertisement request 60. At operation 238, the advertisement distribution module 50 reads the advertisement 80 from the advertisement table 152 based on the advertisement identifier 76 and communicates the advertisement 80 to the user computer 22. Other embodiments may include the advertisement distribution module 50 retrieving or generating the advertisement 80 based on one or more fields in the advertisement request 60 (e.g., digital content identifier 62, the user identifier 64, the advertisement identifier 76).

At operation 240, at the user computer 22, the media application 32 receives and communicates the advertisement 80 to the rendering module 34. At operation 242, the rendering module 34 receives and buffers the advertisement 80.

At operation 246, the media application 32, executes the play advertisement command 118 on the playlist 90 by requesting the rendering module 34 to play the advertisement 80. At operation 248, the rendering module 34 receives the request to play the advertisement 80 and plays the advertisement 80 on the speaker(s) 38 and display 40. At operation 250, the rendering module 34 signals the media application 32 that the rendering module 34 has completed playing the advertisement 80.

Continuing on FIG. 13, at operation 252, the media application 32 communicates the license request 58 to the license server 30. For example, the license request 58 may include the digital content identifier 62, the user identifier 64, the license identifier 68, the content server network address 70, the user computer network address 66, the request date 72, and the request time 74.

At operation 254, the license distribution module 54, at the license server 30, receives the license request 58. At operation 256, the license distribution module 54 generates the license timestamp 100 and queues the license timestamp 100 on the license timestamp queue. For example, the license distribution module 54 may generate the license timestamp 100 by copying the license request 58 into the license timestamp 100, generating the license delay time 75, and storing the license delay time 75 in the license timestamp 100. In one embodiment the license distribution module 54 may generate the license delay time 75 based on the license identifier 68. In another embodiment, the license distribution module 54 may generate the license delay time 75 based on other information or a combination of other information in the license request 58 (e.g., digital content identifier 62, user identifier 64, license identifier 68, etc.).

At operation 258, the license distribution module 54 reads the next license timestamp 100 on the license time stamp queue.

At decision operation 260, the license distribution module 54 determines if the license delay time 75 has expired. For example, the license distribution module 54 may add the license delay time 75 to the request time 74 to generate a delay expiration time. If the current time is greater than the delay expiration time, then the license distribution module 54 branches to operation 262.

At operation 262, the license distribution module 54 generates and communicates the license 82 to the user computer 22. For example, the license distribution module 54 may generate the license 82 based on the license request 58. In one embodiment, the digital content identifier 62 may be used to generate the contents of the license 82 (e.g., the attributes 108, the instructions 110, etc.). In another embodiment, other fields in the license request 58 (e.g., digital content identifier 62, the user identifier 64, the license identifier 68, etc.) may be used to generate the license 82. In yet another embodiment combinations of fields in the license request 58 (e.g., digital content identifier 62, the user identifier 64, the license identifier 68, etc.) may be used to generate the license 82. In the present embodiment, the decryption delay time 112 is set to zero. Accordingly, a request to decrypt the encrypted digital content 92 (e.g., play digital content command 116) may not be ignored based on the decryption delay time 112.

At decision operation 264, the license distribution module 54 determines if there are more license timestamps 100 on the license timestamp queue. If there are more license timestamps 100 on the license timestamp queue then a branch is made to operation 258. Otherwise processing ends at the license server 30.

At operation 266, the media application 32, at the user computer 22, receives and communicates the license 82 to the decryption engine 36. At operation 268, the decryption engine 36, at the user computer 22, receives the license 82.

At operation 270, the media application 32, executes the play digital content command 116 on the playlist 90 by requesting the decryption engine 36 to decrypt and play the encrypted digital content 92.

At operation 272, the decryption engine 36 receives the request to play the encrypted digital content 92 and responsive to the request executes the instructions 110 (e.g., rules) in the license 82. In the present embodiment, the decryption engine 36 grants the request to decrypt the encrypted digital content 92 and uses the key 106 to decrypt the encrypted digital content 92.

At operation 274, the decryption engine 36 communicates the unencrypted digital content 86 to the rendering module 34.

At operation 276, the rendering module 34 plays the unencrypted digital content 86 on the speaker(s) 38 and the display 40.

In another example, the encrypted digital content 92 may be played or accessed without enforcing delay. In yet another example, the user 33 may be denied access to the encrypted digital content 92.

In yet another example, the user 33 may request digital content that may be communicated to the user computer 22 as multiple encrypted digital contents 92. For example, the user may request two episodes of the “I Love Lucy” series. Responsive to the request, the system 20 may communicate digital content information 78 that includes a first encrypted digital content 92 (e.g., first episode) and a second encrypted digital content 92 (e.g., second episode). The first encrypted digital content 92 associated with a first license 82 and a first advertisement 80 and the second encrypted digital content 92 associated with a second license 82 and a second advertisement 80.

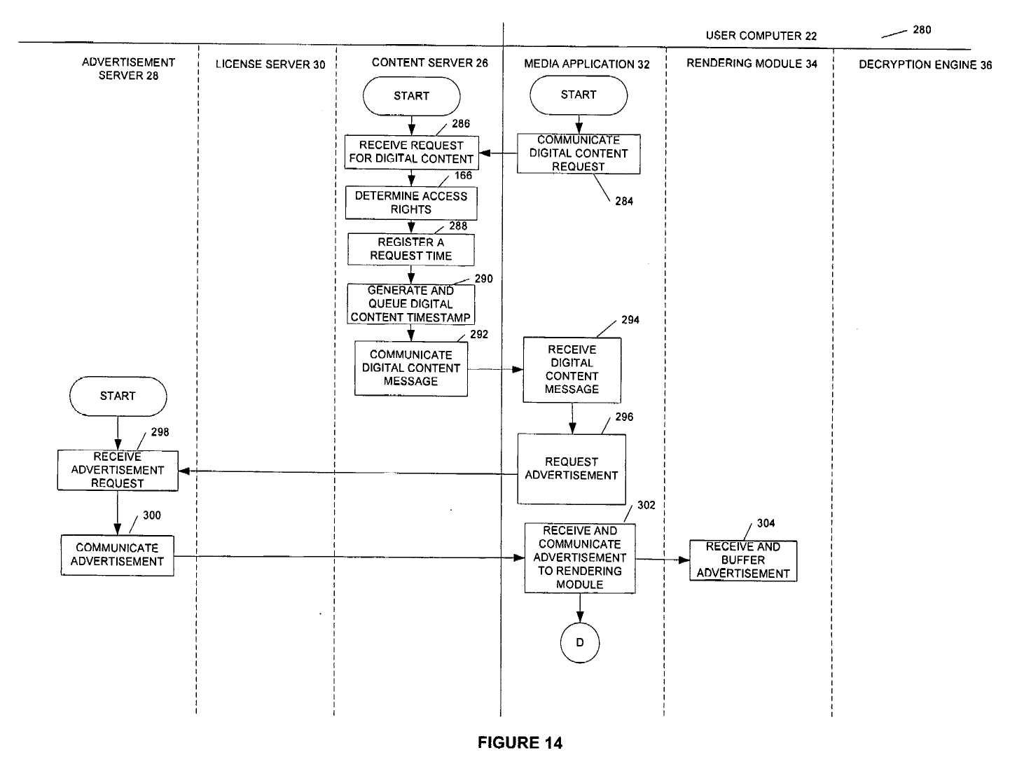

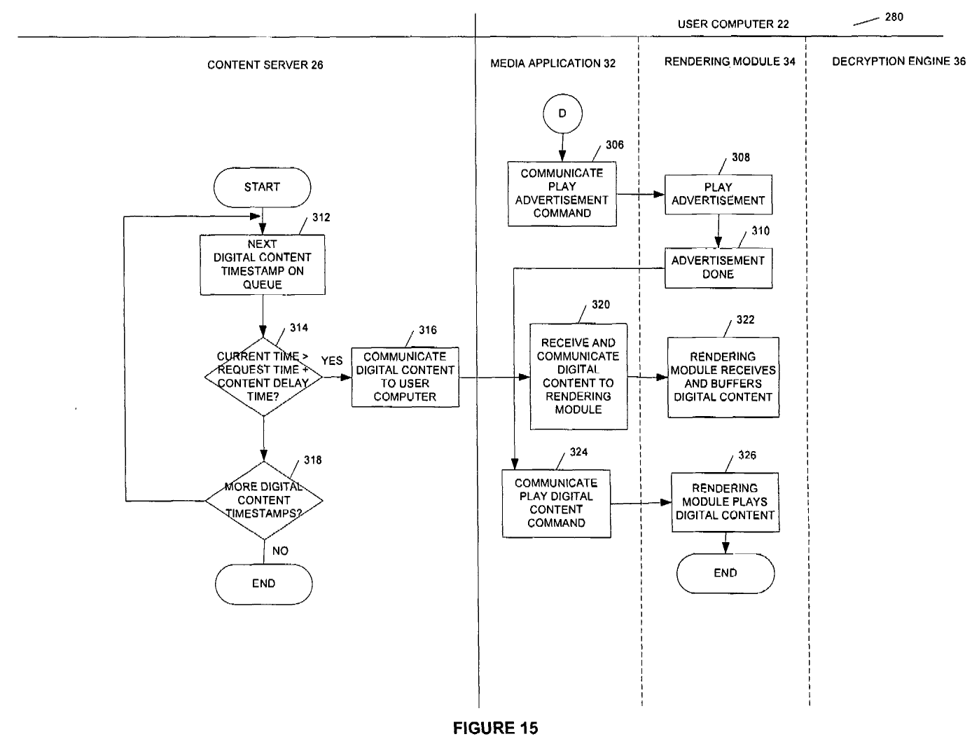

FIGS. 14 and 15 are flow charts illustrating a method 280, according to one embodiment, to enforce delay of access to unencrypted digital content. Illustrated on the left of FIG. 14 are the advertisement server 28, the license server 30, and the content server 26. Illustrated on the right is the user computer 22 including the media application 32, the rendering module 34 and the decryption engine 36. The method 280 commences at the operation 284 with the user 33 requesting the digital content. For example, the user may select a user interface element that causes the digital content request 56 to be generated and communicated to the content server 26 (e.g., a request to stream). The digital content request 56 may include the digital content identifier 62, the user identifier 64, and the user computer network address 66. In one embodiment, the request to stream is implied by the content server 26 that receives the digital content request 56.

At operation 286, the receiving module 46, at the content server 26, receives the digital content request 56 and at operation 166 the receiving module 46 determines the access rights of the user 33 and stores the corresponding access rights identifier 89 in the digital content response 88 of the digital content message 84.

At operation 288, the content distribution module 48 at the content server 26 generates the digital content timestamp 102 and queues the digital content timestamp 102 on a digital content timestamp queue. For example, the content distribution module 48 may generate the digital content timestamp 102 by copying the digital content identifier 62, user identifier 64, and the user computer network address 66 from the digital content request 56 into the corresponding fields of the digital content timestamp 102, generating a content delay time 77, and storing the content delay time 77 in the digital content timestamp 102. In one embodiment the content distribution module 48 may generate the content delay time 77 based on the digital content identifier 62. In another embodiment, the content distribution module 48 may generate the content delay time 77 based on other information or a combination of other information in the digital content request 56 (e.g., digital content identifier 62, user identifier 64, user computer network address 66).

At operation 290, the receiving module 46 registers the request time in response to receiving the request for digital content. For example, the receiving module 46 may store the current date in the request date 72 field of the digital content timestamp 102 and the current time in the request time 74 field of the digital content timestamp 102.

At operation 292, the content distribution module 48 communicates the digital content message 84 to the user computer 22, the digital content message 84 including the digital content response 88, the playlist 90, and the advertisement identifier 76. The content distribution module 48 may generate the playlist 90 based on the digital content request 56 and the access rights of the user (e.g., access rights identifier 89). In the present example, the playlist 90 may include the play advertisement command 118 and the play digital content command 116. The content distribution module 48 may generate the advertisement identifier 76 based on one or more fields of the digital content request 56 (e.g., digital content identifier 62, the user identifier 64, and the user computer network address 66).

At operation 294, the media application 32, at the user computer 22, receives the digital content message 84.

At operation 296, the media application 32, at the user computer 22, communicates the advertisement request 60 to the advertisement server 28. For example, the advertisement request 60 may include the digital content identifier 62, the user identifier 64, and the advertisement identifier 76.

At operation 298, the advertisement server 28 receives the advertisement request 60. At operation 300, the advertisement distribution module 50 reads the advertisement 80 from the advertisement table 152 based on the advertisement identifier 76 and communicates the advertisement 80 to the user computer 22. Other embodiments may include the advertisement distribution module 50 retrieving or generating the advertisement 80 based on one or more fields in the advertisement request 60 (e.g., digital content identifier 62, the user identifier 64, the advertisement identifier 76).

At operation 302, at the user computer 22, the media application 32 receives and communicates the advertisement 80 to the rendering module 34. At operation 304, the rendering module 34 receives and buffers the advertisement 80.

On FIG. 15, at operation 306, the media application 32, executes the play advertisement command 118 on the playlist 90 by requesting the rendering module 34 to play the advertisement 80. At operation 308, the rendering module 34 receives the request to play the advertisement 80 and plays the advertisement 80 on the speaker(s) 38 and display 40. At operation 310, the rendering module 34 signals the media application 32 that the rendering module 34 has completed playing the advertisement 80.

At operation 312, at the content server 26, the content distribution module 48 reads the next digital content timestamp 102 on the digital content timestamp queue. At decision operation 314, the content distribution module 48 determines if the content delay time 77 has expired. For example, the content distribution module 48 may add the content delay time 77 to the request time 74 to generate a delay expiration time. If the current time is greater than the delay expiration time then the license distribution module 54 branches to operation 316. Otherwise the content distribution module 48 branches to decision operation 318.

At operation 316, the content distribution module 48 communicates (e.g., streams) the unencrypted digital content 86 to the user computer 22. For example, the content distribution module 48 may read the unencrypted digital content 86 from the digital content table 132 based on the digital content identifier 62 in the digital content message 84.

At decision operation 318, the content distribution module 48 determines if there are more digital content timestamps 102 on the digital content timestamp queue. If there are more digital content timestamps 102 on the digital content timestamp queue then a branch is made to operation 312. Otherwise processing ends at the content server 26.

At operation 320, the media application 32, at the user computer 22, receives and communicates (e.g., streams) the unencrypted digital content 86 to the rendering module 34. At operation 322, the rendering module 34, at the user computer 22, receives and buffers the unencrypted digital content 86.

At operation 324, the media application 32, executes the play digital content command 116 on the playlist 90. For example, the media application executes the play digital content command 116 by requesting the rendering module 34 to play the unencrypted digital content 86.

At operation 326, the rendering module 34 receives the request to play the unencrypted digital content 86 and responsive to the request plays the unencrypted digital content 86 on the speaker(s) 38 and the display 40.

In another example, the unencrypted digital content 86 may be played or accessed without enforcing delay. In yet another example, the user 33 may be denied access to the unencrypted digital content 86.

In yet another example, the user 33 may request unencrypted digital content that may be communicated to the user computer 22 as multiple unencrypted digital contents 86. For example, the user may request two episodes of the “Andy Griffith” series. Responsive to the request the system 20 may communicate a first unencrypted digital content 86 (e.g., first episode) and a second unencrypted digital content 86 (e.g., second episode). The first unencrypted digital content 86 associated with a first advertisement 80 and the second unencrypted digital content 86 associated with a second advertisement 80.

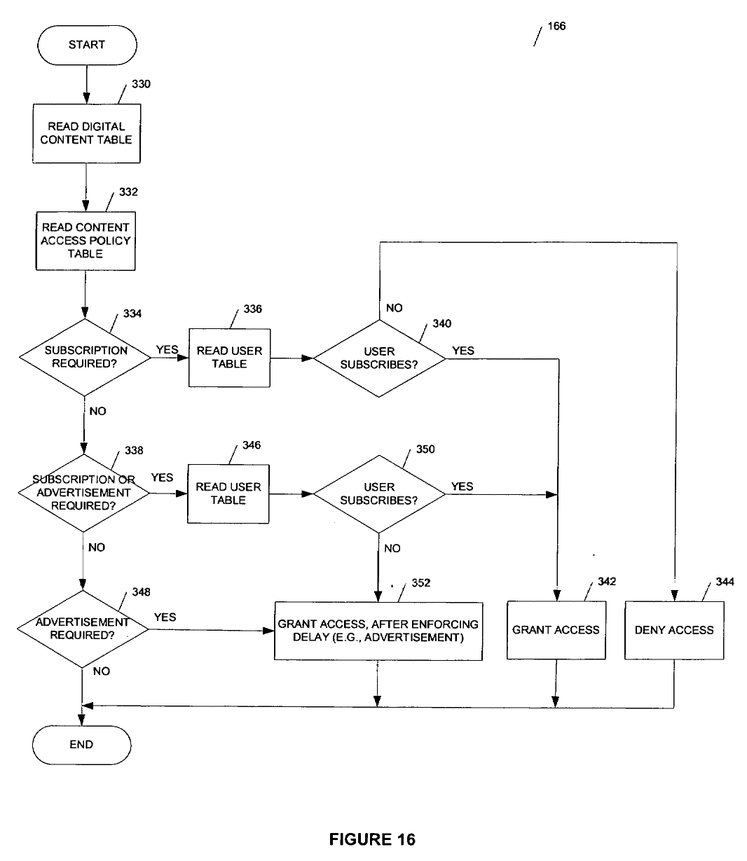

FIG. 16 is a flow chart illustrating the method 166, according to one embodiment, to determine access rights. The method 166 commences at operation 330 with the receiving module 46 reading the digital content table 132 based on the digital content identifier 62 in the digital content request 56. For example, the receiving module 46 may use the digital content identifier 62 to read the policy identifier 142 that may be associated with the corresponding encrypted digital content 92 and unencrypted digital content 86.

At operation 332, the receiving module 46 uses the policy identifier 142 to read the policy information 148 in the content access policy table 134, the policy information 148 including the access policy 150.

At decision operation 334, the receiving module 46 determines if the access policy 150 requires a subscription to access the associated encrypted digital content 92 or the associated unencrypted digital content 86. For example, the access policy 150 may require the user 33 to subscribe to an entertainment service (e.g., HBO, Showtime, etc.) to access the associated digital content 86, 92. Otherwise a branch is made to decision operation 338.

At operation 336, the receiving module 46 reads the subscription flag 138 in the user profile information 136 in the user profile table 130 based on the user identifier 64 in the digital content request 56.

At decision operation 340, the receiving module 46 determines if the subscription flag 138 indicates that the user 33 subscribes to the service (e.g., subscription flag asserted). If the subscription flag 138 indicates the user 33 subscribes to the service then a branch is made operation 342. Otherwise a branch is made to operation 344.

At operation 342 the receiving module 46 initializes the access rights identifier 89 to indicate the user 33 is granted access to the unencrypted digital content 86 or the encrypted digital content 92.

At operation 344 the receiving module 46 initializes the access rights identifier 89 to indicate the user 33 is denied access to the unencrypted digital content 86 or the encrypted digital content 92.

At decision operation 338, the receiving module 46 determines if a subscription or an advertisement (e.g., playing the advertisement to the user 33) is required by the access policy 150 to access the associated encrypted digital content 92 or the associated unencrypted digital content 86. If a subscription or an advertisement is required then a branch is made to operation 346. Otherwise a branch is made to decision operation 348.

At operation 346, the receiving module 46 reads the subscription flag 138 in the user profile information 136 in the user profile table 130 based on the user identifier 64 in the digital content request 56.

At decision operation 350, the receiving module 46 determines if the subscription flag 138 indicates that the user 33 subscribes to a service (e.g., subscription flag asserted). If the subscription flag 138 indicates the user 33 subscribes to the service then a branch is made operation 342. Otherwise a branch is made to operation 352.

At operation 352, the receiving module 46 initializes the access rights identifier 89 to indicate the user 33 is granted access to encrypted digital content 92 or the unencrypted digital content 86 after a delay is enforced.

At decision operation 348, the receiving module 46 determines if playing the advertisement is required by the access policy 150 to access the associated encrypted digital content 92 or the associated unencrypted digital content 86. If playing the advertisement 80 is required then a branch is made to operation 352. Otherwise the process ends.

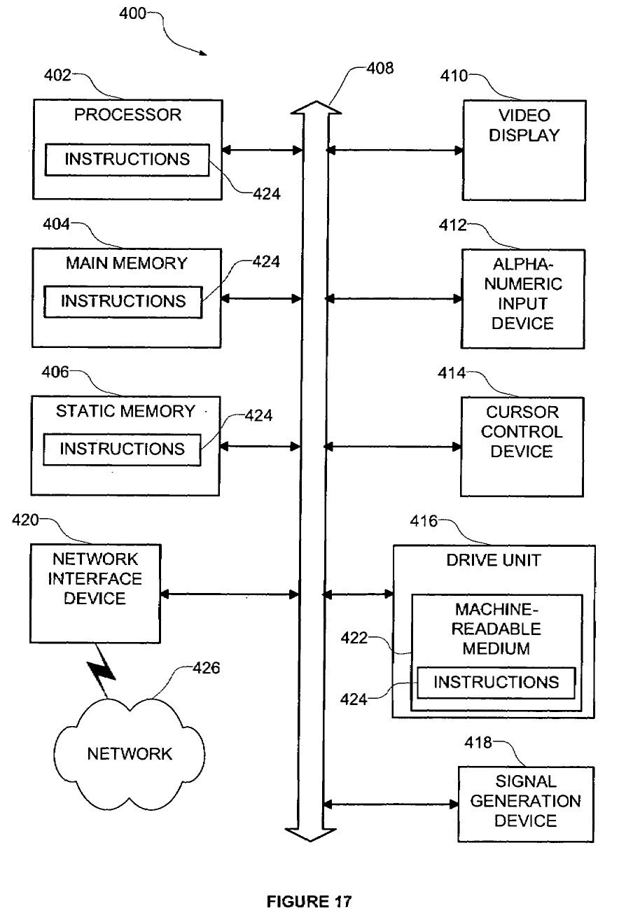

FIG. 17 shows a diagrammatic representation of machine in the example form of a computer system 400 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a digital video recorder, a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 400 includes a processor 402 (e.g., a central processing unit (CPU), a graphics processing unit (GPU) or both), a main memory 404 and a static memory 406, which communicate with each other via a bus 408. The computer system 400 may further include a video display unit 410 (e.g., a liquid crystal display (LCD) or a cathode ray tube (CRT)). The computer system 400 also includes an alphanumeric input device 412 (e.g., a keyboard), a user interface (UI) navigation device 414 (e.g., a mouse), a disk drive unit 416, a signal generation device 418 (e.g., a speaker) and a network interface device 420.

The disk drive unit 416 includes a machine-readable medium 422 on which is stored one or more sets of instructions (e.g., processing instructions) and data structures (e.g., software 424) embodying or utilized by any one or more of the methodologies or functions described herein. The software 424 may also reside, completely or at least partially, within the main memory 404 and/or within the processor 402 during execution thereof by the computer system 400, the main memory 404 and the processor 402 also constituting machine-readable media.

The software 424 may further be transmitted or received over a network 426 via the network interface device 420 utilizing any one of a number of well-known transfer protocols (e.g., HTTP).

While the machine-readable medium 422 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure, or that is capable of storing, encoding or carrying data structures utilized by or associated with such a set of instructions. The term “machine-readable medium” shall accordingly be taken to include, but not be limited to, solid-state memories, optical and magnetic media, and carrier wave signals.

Although an embodiment of the present disclosure has been described with reference to specific example embodiments, it will be evident that various modifications and changes may be made to these embodiments without departing from the broader spirit and scope of the disclosure. Accordingly, the specification and drawings are to be regarded in an illustrative rather than a restrictive sense.

What is claimed is:

1. A system to enforce delay of access to encrypted digital content, the system including:
a receiving module to receive a request for digital content and register a request time responsive to the receiving the request for digital content, the request for digital content including a digital content identifier that identifies the encrypted digital content;
a content distribution module to communicate digital content information based on the request for digital content, the digital content information including the encrypted digital content; and
a license distribution module to communicate a license that delays access to the encrypted digital content based on the request time.

2. The system of claim 1, wherein the license is utilized by a decryption engine to ignore a request to decrypt the encrypted digital content.

3. The system of claim 1, wherein the license is utilized by a decryption engine to grant a request to decrypt the encrypted digital content.

4. The system of claim 3, wherein the license includes a decryption delay time that is added to the request time to enforce the delay of access to the encrypted digital content.

5. A system to enforce delay of access to encrypted digital content, the system including:
a receiving module to receive a request for digital content and register a request time responsive to receiving the request for digital content, the request for digital content including a digital content identifier that identifies the encrypted digital content;
a content distribution module to communicate digital content information based on the request for digital content, the digital content information including the encrypted digital content; and
a license distribution module to communicate a license that enables decryption of the encrypted digital content, the license distribution module to delay the communication of the license, based on the request time, to delay access to the encrypted digital content.

6. The system of claim 5, wherein the license distribution module is to delay the communication of the license for a license delay time after the request time.

7. The system of claim 5, wherein the encrypted digital content includes any one of a group of encrypted digital content including video digital content, multimedia digital content, and audio digital content.

8. The system of claim 5, wherein the digital content information includes a plurality of encrypted digital content that are respectively associated with a plurality of licenses that delay decryption of the respective encrypted digital content.

9. The system of claim 5, wherein the encrypted digital content is associated with policy information that requires that an advertisement be played.

10. The system of claim 9, wherein the advertisement includes any one of a group including a commercial presentation, a public announcement, and a legal warning.

11. A system to enforce delay of access to unencrypted digital content, the system including:
a receiving module to receive a request for digital content and to register a request time responsive to the receiving the request for digital content, the request for digital content including a digital content identifier that identifies the unencrypted digital content; and
a content distribution module to communicate the unencrypted digital content, the content distribution module to delay communication of the unencrypted digital content, based on the request time, to delay access to the unencrypted digital content.

12. The system of claim 11, wherein the content distribution module delays the communication of the unencrypted digital content for a content delay time after the request time.

13. The system of claim 12, further including an advertisement distribution module to communicate an advertisement responsive to receipt of the request for digital content and before the content distribution module is to communicate the unencrypted digital content.

14. The system of claim 12, wherein the advertisement includes any one of a group including a commercial presentation, a public announcement, and a legal warning.

15. A method to enforce delay of access to encrypted digital content, the method including:
receiving a request for digital content that includes a digital content identifier that identifies the encrypted digital content;
registering a request time responsive to the receiving the request for digital content;
communicating digital content information based on the request for digital content, the digital content information including the encrypted digital content; and
communicating a license that delays access to the encrypted digital content based on the request time.

16. The method of claim 15, wherein the license is utilized by a decryption engine to ignore a request to decrypt the encrypted digital content.

17. The method of claim 15, wherein the license is utilized by a decryption engine to grant a request to decrypt the encrypted digital content.

18. The method of claim 17, wherein the license includes a decryption delay time that is added to the request time.

19. A method to enforce delay of access to encrypted digital content, the method including:
receiving a request for digital content that includes a digital content identifier that identifies the encrypted digital content;
registering a request time responsive to receiving the request for digital content;
communicating digital content information based on the request for digital content, the digital content information including the encrypted digital content; and
communicating a license that enables decryption of the encrypted digital content, the communicating the license delayed, based on the request time, to delay access to the encrypted digital content.

20. The method of claim 19, wherein the communicating the license is delayed for a license delay time after the request time.

21. The method of claim 19, wherein the encrypted digital content includes any one of a group of encrypted digital content including video digital content, multimedia digital content, and audio digital content.

22. The method of claim 19, wherein the encrypted digital content information includes a plurality of encrypted digital content that are respectively associated with a plurality of licenses that delay decryption of the respective encrypted digital content.

23. The method of claim 19, wherein the encrypted digital content is associated with policy information that requires that an advertisement be played.

24. The method of claim 23, wherein the advertisement includes any one of a group including a commercial presentation, a public announcement, and a legal warning.

25. A method to enforce delay of access to unencrypted digital content, the method including:
receiving a request for digital content that includes a digital content identifier that identifies the unencrypted digital content;
registering a request time responsive to the receiving the request for digital content; and
communicating the unencrypted digital content, the communication of the unencrypted digital content delayed, based on the request time, to delay access to the unencrypted digital content.

26. The method of claim 25, wherein the communicating the unencrypted digital content is delayed for a content delay time after the request time.

27. The method of claim 26, further including communicating an advertisement responsive to receipt of the request for unencrypted digital content and before the communicating the unencrypted digital content.

28. The method of claim 26, wherein the advertisement includes any one of a group including a commercial presentation, a public announcement, and a legal warning.

29. A tangible machine readable medium storing a set of instructions that, when executed by a machine, cause the machine to:
receive a request for digital content and register a request time responsive to the receipt of the request for digital content, the request for digital content including a digital content identifier that identifies encrypted digital content;
communicate digital content information based on the request for digital content, the digital content information including the encrypted digital content; and
communicate a license that delays access to the encrypted digital content based on the request time.

30. A tangible machine readable medium storing a set of instructions that, when executed by a machine, cause the machine to:
receive a request for digital content and register a request time responsive to receiving the request for digital content, the request for digital content including a digital content identifier that identifies encrypted digital content;
communicate digital content information based on the request for digital content, the digital content information including the encrypted digital content; and
communicate a license that enables decryption of the encrypted digital content, the license distribution module to delay the communication of the license, based on the request time, to delay access to the encrypted digital content.

31. A tangible machine readable medium storing a set of instructions that, when executed by a machine, cause the machine to:
receive a request for unencrypted digital content and to register a request time responsive to the receiving the request for digital content, the request for digital content including a digital content identifier that identifies unencrypted digital content; and
communicate unencrypted digital content, the content distribution module to delay communication of the unencrypted digital content, based on the request time, to delay access to the unencrypted digital content.

32. A system to enforce delay of access to unencrypted digital content, the system including:
a first means for receiving a request for digital content and to register a request time responsive to the receiving the request for digital content, the request for digital content including a digital content identifier that identifies the unencrypted digital content; and
a second means for communicating the unencrypted digital content, the second means to delay communication of the unencrypted digital content, based on the request time, to delay access to the unencrypted digital content.
